(19) United States
(12) Patent Application Publication
(10) Pub. No.: US 2024/0205946 A1
(43) Pub. Date: Jun. 20, 2024

(54) SIDELINK COMMUNICATION METHOD AND APPARATUS, AND STORAGE MEDIUM

(71) Applicant: Beijing Xiaomi Mobile Software Co., Ltd., Beijing (CN)

(72) Inventor: Qun ZHAO, Beijing (CN)

(73) Assignee: Beijing Xiaomi Mobile Software Co., Ltd., Beijing (CN)

(21) Appl. No.: 18/554,539

(22) PCT Filed: Apr. 9, 2021
(86) PCT No.: PCT/CN2021/086203

§ 371 Date: Oct. 9, 2023

(51) Int. Cl. H04W 72/40; H04L 5/00; H04W 72/51; H04W 92/18

(52) U.S. Cl. CPC H04W 72/40; H04L 5/0048; H04W 72/51; H04W 92/18

(57) ABSTRACT

A sidelink communication method that can include determining a sidelink ranging resource set configuration parameter, on the basis of the sidelink ranging resource set configuration parameter, determining a sidelink ranging resource, and by means of the sidelink ranging resource, transmitting a sidelink ranging signal.

### CROSS REFERENCE TO RELATED APPLICATION

This application is a National Stage of International Application No. PCT/CN2021/086203, filed on Apr. 9, 2021, which is incorporated by reference herein in its entireties for all purposes.

### BACKGROUND

### Technical Field

This disclosure relates to the field of communication technologies, and in particular, to a sidelink communication method and apparatus, and a storage medium.

### Description of the Related Art

With the continuous emergence of a new generation of Internet applications, the continuous evolution of wireless communication technology is driven to meet the needs of applications.

Applications and services based on the distance and angle between user equipments (UEs) are currently emerging. By measuring the distance and angle through wireless signals, the wireless communication capability of UE can be effectively utilized, and new UE capabilities can be introduced. Terminals and wireless network devices that support ranging function are able to control and operate the measurement of distance and angle in a more convenient manner, thereby being applicable to a variety of commercial and vertical application scenarios, such as smart home, smart city, smart transportation, smart retail, and the like.

With the development of the new generation of 5G mobile communication technology, the technology of using the new ratio (NR) cellular communication network uplink and downlink transmission for UE positioning has been studied in 3GPP Rel-16. However, how to use the NR sidelink for inter-user ranging has not been discussed. 3GPP Rel-16 supports sidelink communication for Internet of vehicle (IoV) scenarios. It may be possible to use sidelink for inter-user ranging or positioning in subsequent versions of NR. However, in sidelink ranging or positioning, how to provide sidelink ranging resources for sidelink ranging signals used for sidelink ranging or positioning needs to be studied.

### SUMMARY

This disclosure relates to the field of communication technologies, and in particular, to a sidelink communication method and apparatus, and a storage medium.

In order to overcome the problems existing in the related art, this disclosure provides a sidelink communication method and apparatus, and a storage medium.

According to a first aspect of the embodiments of this disclosure, a sidelink communication method is provided and includes determining a sidelink ranging resource set configuration parameter, and determining a sidelink ranging resource based on the sidelink ranging resource set configuration parameter, and performing transmission of sidelink ranging signal through the sidelink ranging resource.

According to a second aspect of the embodiments of this disclosure, there is provided a sidelink communication device, including a processor and a memory for storing instructions executable by the processor. The processor is configured to implement the sidelink communication method according to the first aspect or any embodiment thereof.

According to a third aspect of the embodiments of this disclosure, there is provided a storage medium for storing instructions therein, where the instructions in the storage medium, when being executed by a processor of a user equipment, cause the user equipment to implement the sidelink communication method according to the first aspect or any embodiment thereof.

The technical solutions provided by some embodiments of this disclosure may include the following beneficial effects. The sidelink ranging resource is determined based on the sidelink ranging resource set configuration parameter, so as to determine the time-frequency resource(s) occupied by the sidelink ranging signal during the sidelink ranging or positioning, thereby facilitating the sidelink ranging or positioning.

It is to be understood that the foregoing general description and the following detailed description are exemplary and explanatory only and are not restrictive of this disclosure.

### BRIEF DESCRIPTION OF THE DRAWINGS

The accompanying drawings, which are incorporated in and constitute a part of this specification, illustrate embodiments consistent with the disclosure and together with the description serve to explain the principles of the disclosure.

FIG. 1 is a schematic diagram of a sidelink communication system according to an exemplary embodiment.

FIG. 2 is a flow chart of a sidelink communication method according to an exemplary embodiment.

FIG. 3 is a flow chart of a sidelink communication method according to an exemplary embodiment.

FIG. 4 is a flow chart of a sidelink communication method according to an exemplary embodiment.

FIG. 5 is a flow chart of a sidelink communication method according to an exemplary embodiment.

FIG. 6 is a flow chart of a sidelink communication method according to an exemplary embodiment.

FIG. 7 is a flow chart of a sidelink communication method according to an exemplary embodiment.

FIG. 8 is a flow chart of a sidelink communication method according to an exemplary embodiment.

FIG. 9 is a flow chart of a sidelink communication method according to an exemplary embodiment.

FIG. 10 is a flow chart of a sidelink communication method according to an exemplary embodiment.

FIG. 11 is a block diagram of a sidelink communication apparatus according to an exemplary embodiment.

FIG. 12 is a block diagram of a sidelink communication device according to an exemplary embodiment.

### DETAILED DESCRIPTION OF THE PREFERRED EMBODIMENTS

Exemplary embodiments will be described in detail herein, examples of which are illustrated in the accompanying drawings. Where the following description refers to the drawings, the same numerals in different drawings refer to the same or similar elements unless otherwise indicated. The implementations described in the illustrative embodiments below are not intended to represent all implementations consistent with this disclosure. Rather, they are merely examples of apparatus and methods consistent with some aspects of this disclosure as recited in the appended claims.

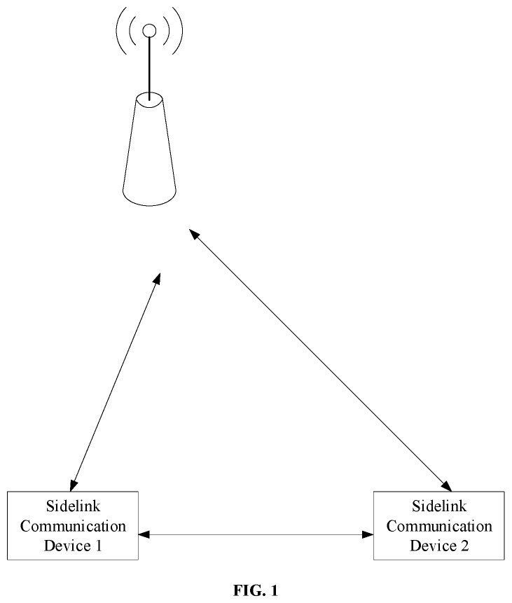

The sidelink communication method according to some embodiments of this disclosure can be applied to the sidelink communication system shown in FIG. 1. Referring to FIG. 1, in the scenario of sidelink communication between sidelink communication devices, the network device configures the sidelink communication device 1 with various transmission parameters for data transmission. The sidelink communication device 1 may be used as a data sending end, and the sidelink communication device 2 may be used as a data receiving end, and the two devices perform sidelink communication. The link for communication between the network device and the sidelink communication device includes uplink and downlink, and the link between the sidelink communication devices is sidelink.

In this disclosure, the communication scenario of sidelink communication between sidelink communication devices may also be a Device to Device (D2D) communication scenario. The sidelink communication devices that perform sidelink communication in some embodiments of this disclosure may include various handheld devices, vehicle-mounted devices, wearable devices and computing devices with wireless communication functions, or other processing devices connected to wireless modems, as well as various forms of users equipment (UE), mobile station (MS), terminal, terminal equipment and the like. For convenience of description, the embodiments of this disclosure are described below by taking the sidelink communication device being UE as an example.

At present, the physical layer channels in the NR sidelink communication system include Physical Sidelink Broadcast Channel (PSBCH). Physical Sidelink Share Channel (PSSCH). Physical Sidelink Control Channel (PSCCH) and Physical Sidelink Feedback Channel (PSFCH); and the physical layer reference signals include Primary Sidelink Synchronization Signal (PSSS). Secondary Sidelink Synchronization Signal (SSSS). Demodulation Reference Signal (DMRS). Channel-state information Reference Signal (CSI-RS). Phase Tracking Reference Signal (PT-RS) and so on. Since the requirement of ranging through the sidelink signal has not been considered in the existing NR sidelink communication system, due to different design purposes, the existing channels or reference signals in the NR sidelink communication system are not suitable for ranging use. For ranging through sidelink signals, it is necessary to design dedicated sidelink ranging signals and sidelink ranging resources.

For sidelink ranging or positioning, a ranging signal transmitter sends a sidelink ranging signal, and a ranging signal receiver performs measurement according to the sidelink ranging signal, and determines the distance and/or angle between the transmitter and the receiver by means of time measurement or angle measurement. Unlike NR ranging, where one end of the transmission and reception of the positioning reference signal is the base station, both the transmitter and the receiver of the sidelink ranging or positioning are UEs.

For a sidelink ranging UE, it may be within the coverage of the base station, or it may be outside the coverage of the base station. Even if it is within the coverage of the base station, it may be in the Radio Resource Control (RRC) idle state, so it is impossible to completely rely on the configuration or instructions from the base station to determine the sidelink ranging resource(s) for sidelink ranging or positioning.

Some embodiments of this disclosure provide a sidelink communication method, in which a UE sends a sidelink ranging signal by using a sidelink ranging resource in a sidelink ranging resource set, thereby realizing the allocation of sidelink ranging resources as well as performing the sidelink ranging.

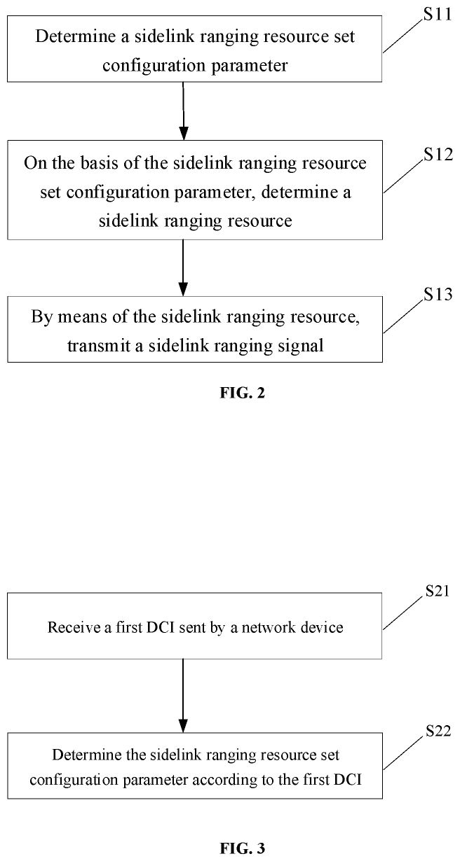

FIG. 2 is a flow chart of a sidelink communication method according to an exemplary embodiment. As shown in FIG. 2, the sidelink communication method is applied in in a UE and includes the following steps.

In step S11, a sidelink ranging resource set configuration parameter is determined. In some embodiments of this disclosure, the sidelink ranging resource set configuration parameter may be understood as a configuration parameter used to determine a sidelink ranging resource set (also referred to as a sidelink ranging resource collection).

In step S12, a sidelink ranging resource(s) is determined based on the sidelink ranging resource set configuration parameter. In some embodiments of this disclosure, the sidelink ranging resource may also be referred to as direct-connection ranging resource. In some embodiments of this disclosure, the two terms are sometimes used interchangeably, and those skilled in the art should understand the consistency of their meanings.

The sidelink ranging resource may be frequency resource, time resource, or time resource and frequency resource.

In step S13, transmission of a sidelink ranging signal is performed through the sidelink ranging resource. In some embodiments of this disclosure, the sidelink ranging signal may be understood as a signal used for sidelink ranging or positioning between UEs that communicate based on sidelink. The sidelink ranging signal can be measured between the UEs, and the distance and/or angle between the UEs can be determined by means of, for example, time measurement or angle measurement.

In the sidelink communication method according to some embodiments of this disclosure, the UE determines the sidelink ranging resource based on the sidelink ranging resource set configuration parameter, and performs transmission of the sidelink ranging signal through the sidelink ranging resource, thereby enabling the UE to sends the sidelink ranging signal by using the sidelink ranging resource in the sidelink ranging resource set, so the sidelink ranging resource can be determined and the sidelink ranging can be effectively performed.

In the sidelink communication method according to some embodiments of this disclosure, the sidelink ranging resource set used by the UE for sidelink ranging may be a periodic sidelink ranging resource set. That is, the sidelink ranging resource set configured by the sidelink ranging resource set configuration parameter is a periodic sidelink ranging resource set.

In some embodiments, the periodic sidelink ranging resource set includes one or more groups of sidelink ranging resources in each resource period, each group of sidelink ranging resources includes one or more sidelink ranging resources, and each sidelink ranging resource is a resource in the same time unit. Herein, the time unit may be a slot, a subframe, a symbol, and the like.

In the sidelink communication method according to some embodiments of this disclosure, each sidelink ranging resource in the same group within the periodic sidelink ranging resource set has the same location and size in the time unit.

In the sidelink communication method according to some embodiments of this disclosure, the periodic sidelink ranging resource set includes multiple groups of sidelink ranging resources in the same resource period. The multiple groups of sidelink ranging resources are configured by multiplexing time-domain resources in a time-division manner, and/or by multiplexing frequency-domain resources in a frequency-division manner.

In an example, the sidelink ranging resource set is a periodic sidelink ranging resource set: each period includes one or more groups of sidelink ranging resources: each group of sidelink ranging resources includes one or more sidelink ranging resources: each sidelink ranging resource is within one time unit: and each sidelink ranging time-frequency resource within the same group has the same location and size within the time unit. Different groups of sidelink ranging resources can be multiplexed by means of time division or frequency division.

In the sidelink communication method according to some embodiments of this disclosure, when the different groups of sidelink ranging resources are multiplexed in the frequency division multiplexing manner, the frequency-domain resources may be multiplexed in a comb (or comb-shaped) frequency division multiplexing manner. In some embodiments, when the frequency-domain resources are multiplexed in the comb frequency division multiplexing manner, the frequency-domain resources are multiplexed based on a comb frequency division multiplexing factor. The comb frequency division multiplexing factor is used to indicate configuration information of resource elements (REs) occupied when the frequency-domain resources are multiplexed in the comb frequency division multiplexing manner. For example, the configuration information may include the number of REs, and/or the spacing between two adjacent REs.

In some embodiments of this disclosure, one UE may be configured with multiple sidelink ranging resource sets, and the sidelink ranging resource set configuration parameters corresponding to respective sidelink ranging resource sets may be different. For example, the comb frequency division multiplexing factors corresponding to respective sidelink ranging resource sets may be different.

In some embodiments, the sidelink ranging resource set configuration parameter is used to configure multiple different sidelink ranging resource sets.

In some embodiments, the sidelink ranging resource set configuration parameter includes a comb frequency division multiplexing factor, and different sidelink ranging resource sets correspond to different comb frequency division multiplexing factors.

In the sidelink communication method according to some embodiments of this disclosure, in response to one UE being configured with multiple sidelink ranging resource sets, the UE may select an appropriate sidelink ranging resource set by receiving a downlink signaling indication from a network device, or according to an upper layer indication of the UE or characteristics (e.g., distance, accuracy, delay requirements and the like) of the ranging service.

In some embodiments of this disclosure, the sidelink ranging resource set configuration parameter determined by the UE may include at least one of the following a period length, the number and time-domain spacing of each group of sidelink ranging resources within a period, a time-domain start position and a time-domain length of each group of sidelink ranging resources in a time unit within the period, and a frequency-domain start position and a frequency-domain length of each group of sidelink ranging resources in the time unit within the period.

In the sidelink communication method according to some embodiments of this disclosure, the UE can obtain the sidelink ranging resource set configuration parameter by receiving a downlink signal sent by the network device, or in a preconfigured or predefined manner. In other words, the UE may determine the sidelink ranging resource set configuration parameter in one of the following manners.

In Manner 1, a downlink signal sent by the network device is received, the sidelink ranging resource set configuration parameter is determined according to the downlink signal.

Herein, the downlink signal sent by the network device in some embodiments of this disclosure may be downlink control information (DCI). For convenience of description below; the DCI used for determining the sidelink ranging resource set configuration parameter is referred to as the first DCI.

FIG. 3 is a flow chart of a sidelink communication method according to an exemplary embodiment. As shown in FIG. 3, the sidelink communication method is applied in UE and includes the following steps.

In step S21, the first DCI sent by the network device is received.

In step S22, the sidelink ranging resource set configuration parameter is determined according to the first DCI.

In Manner 2, the sidelink ranging resource set configuration parameter is determined based on the pre-configuration information (preconfigured or predefined).

Hereinafter, for the convenience of description, the pre-configuration information for determining the sidelink ranging resource set configuration parameter is referred to as the first pre-configuration information.

FIG. 4 is a flow chart of a sidelink communication method according to an exemplary embodiment. As shown in FIG. 4, the sidelink communication method is applied in UE and includes the following steps.

In step S31, the sidelink ranging resource set configuration parameter is determined based on the first pre-configuration information.

In the sidelink communication method provided by this disclosure, the sidelink ranging resource set configuration parameter determined based on the first DCI or the first pre-configuration information is used to indicate the sidelink ranging resource set. For example, the sidelink ranging resource set configuration parameter is used to indicate the period length of each ranging resource set in the periodic sidelink ranging resource set: the number and time-domain spacing of each group of sidelink ranging resources in the period; the time-domain start position and time-domain length of each group of sidelink ranging resources in a time unit: and the frequency-domain start position and frequency-domain length of each group of sidelink range resources in the time unit within a period. Further, the UE can determine the sidelink ranging resource set based on the sidelink ranging resource set configuration parameter.

In the sidelink communication method according to some embodiments of this disclosure, the UE may send the sidelink ranging signal by using a certain sidelink ranging resource(s), which is autonomously selected or determined based on the downlink control signal sent by the network device, in the sidelink ranging resource set.

In some embodiments of this disclosure, for convenience of description, the downlink control signal used by the UE to determine the sidelink ranging resource in the sidelink ranging resource set is referred to as the second DCI. The DCI may be semi-static RRC signaling or dynamic DCI signaling.

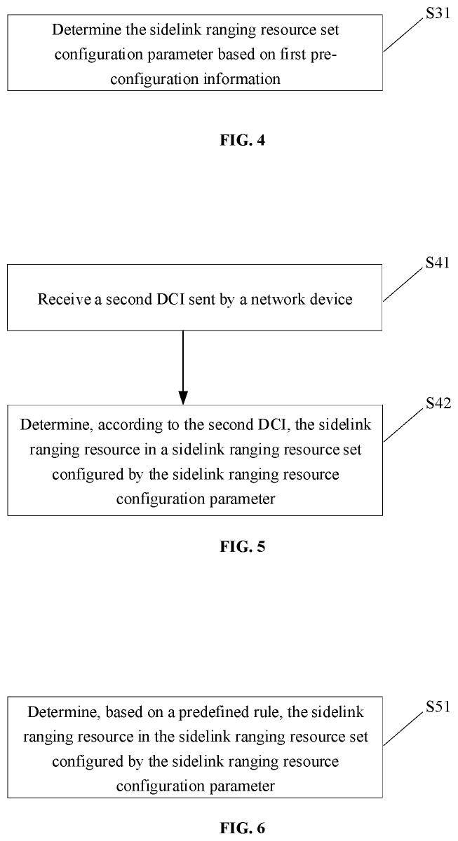

FIG. 5 is a flow chart of a sidelink communication method according to an exemplary embodiment. As shown in FIG. 5, the sidelink communication method is applied in UE includes the following steps.

In step S41, the second DCI sent by the network device is received.

In step S42, the sidelink ranging resource is determined according to the second DCI in the sidelink ranging resource set configured by the sidelink ranging resource set configuration parameter.

FIG. 6 is a flowchart of a sidelink communication method according to an exemplary embodiment. As shown in FIG. 6, the sidelink communication method is applied in UE and includes the following steps.

In step S51, based on a predefined rule, the sidelink ranging resource is determined in the sidelink ranging resource set configured by the sidelink ranging resource set configuration parameter.

In the sidelink communication method according to some embodiments of this disclosure, the number of sidelink ranging resource sets may be one or more. Herein, when there are multiple sidelink ranging resource sets, the multiple sidelink ranging resource sets may be different sidelink ranging resource sets.

Herein, there may be one or more sidelink ranging resource configuration parameters for determining multiple different sidelink ranging resource sets. In other words, on the one hand, multiple different sidelink ranging resource sets may be configured through one sidelink ranging resource configuration parameter, that is, the sidelink ranging resource set configuration parameter can be in a one-to-many relationship. On the other hand, multiple different sidelink ranging resource sets may also be configured through multiple different sidelink ranging resource set configuration parameters. Herein, the sidelink ranging resource set configuration parameters and the sidelink ranging resource sets may be in one-to-one correspondence (one sidelink ranging resource set configuration parameter configures one sidelink ranging resource set), or may be in one-to-many correspondence (one sidelink ranging resource set configuration parameter configures multiple sidelink ranging resource sets).

In the sidelink communication method according to some embodiments of this disclosure, different sidelink ranging resource set configuration parameters may be configured for the UE according to different resource selection manners, for example, according to allocation of the base station or autonomous selection of the UE, so as to determine the sidelink ranging resource(s) for transmission of the sidelink ranging signal. In an example, the UE is configured with two sidelink ranging resource set configuration parameters, which are the sidelink ranging resource set configuration parameter 1 and the sidelink ranging resource set configuration parameter 2, respectively. When determining the sidelink ranging resource, on the one hand, if it is allocated by the base station, the resource set configuration parameter 1 may be used to determine the sidelink ranging resource. On the other hand, if it is autonomously selected by the UE itself, the resource set configuration parameter 2 may be used to determine the sidelink ranging resource.

In the sidelink communication method according to some embodiments of this disclosure, after determining the sidelink ranging resource, the UE can perform transmission of the sidelink ranging signal through the sidelink ranging resource, and perform the sidelink ranging.

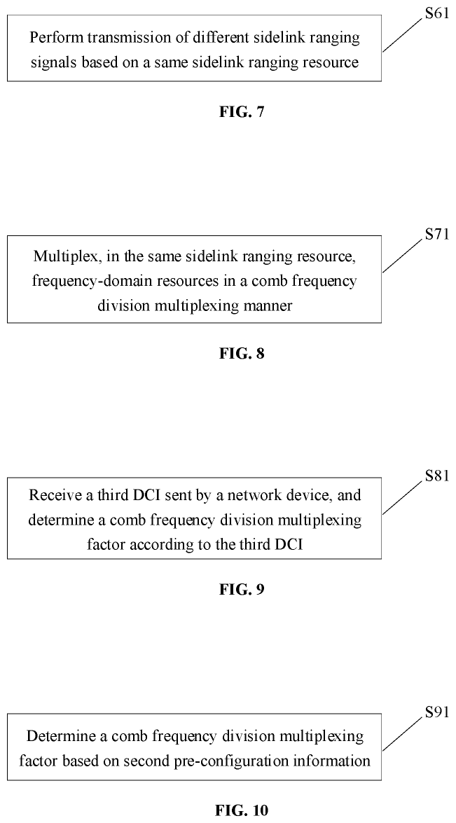

FIG. 7 is a flow chart showing a sidelink communication method according to an exemplary embodiment. As shown in FIG. 7, the sidelink communication method is applied in UE and includes the following steps.

In step S61, different sidelink ranging signals are transmitted based on the same sidelink ranging resource.

In some embodiments, the UE may perform transmission of different sidelink ranging signals based on the same sidelink ranging resource, that is, by multiplexing the sidelink ranging resource(s) for different sidelink ranging signals.

Herein, for the multiplexing of the sidelink ranging resources, time-domain resources may be multiplexed in a time-division multiplexing manner, or frequency-domain resources may be multiplexed in a frequency division multiplexing manner.

In the sidelink communication method according to some embodiments of this disclosure, the UE may adopt the comb frequency division multiplexing manner to multiplex the frequency-domain resource in the same sidelink ranging resource.

FIG. 8 is a flow chart of a sidelink communication method according to an exemplary embodiment. As shown in FIG. 8, the sidelink communication method is applied in UE and includes the following steps.

In step S71, the frequency-domain resource is multiplexed in the same sidelink ranging resource by adopting the comb frequency division multiplexing manner.

Herein, when the frequency-domain resource is multiplexed in the comb frequency division multiplexing manner, the frequency-domain resource may be multiplexed based on a comb frequency division multiplexing factor. The comb frequency division multiplexing factor is used to indicate the configuration information of REs occupied when the frequency-domain resource is multiplexed in the comb frequency division multiplexing manner. For example, the configuration information may include the number of REs, and/or the spacing between two adjacent REs.

In other words, in the sidelink communication method according to some embodiments of this disclosure, different sidelink ranging signals transmitted in each sidelink ranging resource may be multiplexed and transmitted in a frequency-domain comb manner.

In the sidelink communication method according to some embodiments of this disclosure, when the UE performs multiplexing and transmission in the frequency-domain comb manner, the comb frequency division multiplexing factor may need to be determined.

In the sidelink communication method according to some embodiments of this disclosure, the UE may determine the comb frequency division multiplexing factor based on a downlink signal sent by the network device, or in a preconfigured or predefined manner. The comb frequency division multiplexing factor is used to indicate the configuration information of REs occupied when the frequency-domain resource is multiplexed in the comb frequency division multiplexing manner.

On one hand, in some embodiments of this disclosure, the downlink control signal used for determining the comb frequency division multiplexing factor is referred to as the third DCI. In other words, the UE may determine the comb frequency division multiplexing factor according to the third DCI.

FIG. 9 is a flow chart showing a sidelink communication method according to an exemplary embodiment. As shown in FIG. 9, the sidelink communication method is applied in UE and includes the following steps.

In step S81, the third DCI sent by the network device is received, and the comb frequency division multiplexing factor is determined according to the third DCI.

On the other hand, the pre-configuration information for determining the comb frequency division multiplexing factor is referred to as the second pre-configuration information. In other words, the UE can determine the comb frequency division multiplexing factor according to the second pre-configuration information.

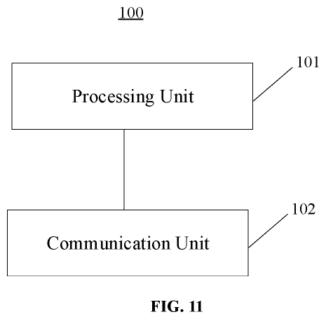

FIG. 10 is a flowchart showing a sidelink communication method according to an exemplary embodiment. As shown in FIG. 10, the sidelink communication method is applied in UE and includes the following steps.

In step S91, the comb frequency division multiplexing factor is determined based on the second pre-configuration information.

In the sidelink communication method according to some embodiments of this disclosure, the third DCI and/or the second pre-configuration information may be used to configure the comb frequency division multiplexing factor for each sidelink ranging resource, or to configure the comb frequency division multiplexing factor for the sidelink ranging resource set.

In an example, the determination of the comb frequency division multiplexing factor may be carried out in the following manner.

In Manner 1, the comb multiplexing factor is obtained by receiving the downlink signal from the network device, or in the pre-configured or pre-defined manner.

In Manner 2, a set of comb multiplexing factors are obtained by receiving the downlink signals from the network device, or in the pre-configured or pre-defined manner, and the UE at the sidelink ranging signal sending side selects which comb value to use.

In the sidelink communication method according to some embodiments of this disclosure, different sidelink ranging signals transmitted in each sidelink ranging resource may be multiplexed and transmitted in the frequency-domain comb manner. The comb multiplexing factor may be configured based on each sidelink ranging resource set, or based on the sidelink resource collection (e.g., a sidelink resource pool or a sidelink bandwidth part. BWP) to which the sidelink ranging resource set belongs.

In the sidelink communication method according to some embodiments of this disclosure, when the sidelink ranging signal is transmitted in each sidelink ranging resource, in order to enable the sidelink ranging signal to occupy more bandwidth resources, at least one of the following manners may be adopted for transmission of the sidelink ranging signal.

In Manner 1, the sidelink ranging signal is transmitted by using the sidelink ranging resource with the same frequency-domain width as the sidelink ranging resource set. In other words, when the UE transmits the sidelink ranging signal on the sidelink ranging resource in a certain sidelink ranging resource set, the frequency-domain bandwidth of the transmitted sidelink ranging signal is the same as the frequency-domain width of the sidelink ranging resource.

In Manner 2, the sidelink ranging signal is transmitted by using the sidelink ranging resource with the same time-domain length as the sidelink ranging signal. In other words, the time-domain length of the ranging signal is the same as the time-domain length of the resource.

In some embodiments of this disclosure, considering the time-domain symbols used for automatic gain control (AGC) adjustment and/or guard interval, the sidelink ranging resources may be occupied as much as possible after removing the time-domain symbols used for AGC adjustment and/or guard interval from the sidelink ranging resources.

In Manner 2, the sidelink ranging signal is transmitted by using a period corresponding to an integer multiple of the period of the sidelink ranging resource set. In other words, the transmission period of the ranging signal is equal to the period of the resource set or an integer multiple of the period of the resource set.

In Manner 2, the sidelink ranging signal is repeatedly transmitted within a group of sidelink ranging resources in the same period, and the number of times of repeated transmission of the sidelink ranging signal is less than or equal to the number of sidelink ranging resources in the corresponding group. In other words, the ranging signal in each period may be repeatedly sent within a group of ranging resources in the period, and the number of times of repeated sending does not exceed the number of ranging resources in the group.

In the sidelink link communication method according to some embodiments of this disclosure, based on the above manners configured to transmit the sidelink ranging signal in each sidelink ranging resource, it can be understood that a new format of sidelink ranging signal is provided, which enable the sidelink ranging signal to occupy more bandwidth resources.

Based on the sidelink link communication method according to some embodiments of this disclosure, by configuring the sidelink ranging resource set, and using the sidelink ranging resource(s) in the sidelink ranging resource set for transmission of the sidelink ranging signal, the time-frequency resources and the format of the sidelink ranging signal transmission can be determined without relying on configuration or indication of the network device, and the sidelink ranging can be performed by using the time-frequency resources occupied by the sidelink ranging signal and the format of the sidelink ranging signal which are suitable for ranging between UEs in sidelink communication.

It should be noted that those skilled in the art can understand that the various implementations/embodiments involved in the foregoing embodiments of this disclosure may be used in conjunction with the foregoing embodiments, or may be used independently. Regardless of being used independently or in conjunction with the foregoing embodiments, the implementation principles are similar. In the implementation of this disclosure, some embodiments are described in terms of implementations that are used together. However, those skilled in the art can understand that such embodiments are not intended to limit the embodiments of this disclosure.

Based on the same concept, some embodiments of this disclosure further provide a sidelink communication apparatus.

It can be understood that, in order to implement the above-mentioned functions, the sidelink communication apparatus according to some embodiments of this disclosure includes corresponding hardware structures and/or software modules for implementing each function. Combining with the units and algorithm steps of each example disclosed in the embodiments of this disclosure, some embodiments of this disclosure may be implemented in hardware or a combination of hardware and computer software. Whether a function is performed by hardware or computer software driving hardware depends on the specific application and design constraints of the technical solution. Those skilled in the art may use different manners to implement the described functions for each specific application, but such implementation should not be considered beyond the scope of the technical solutions of the embodiments of this disclosure.

FIG. 11 is a block diagram of a sidelink communication apparatus according to an exemplary embodiment. Referring to FIG. 11, the sidelink communication device 100 includes a processing unit 101 and a communication unit 102.

The processing unit 101 is configured to configured to determine a sidelink ranging resource set configuration parameter, and determine a sidelink ranging resource based on the sidelink ranging resource set configuration parameter. The communication unit 102 is configured to perform transmission of sidelink ranging signal through the sidelink ranging resource.

In some embodiments, the communication unit 102 receives a first DCI sent by a network device, and the processing unit 101 determines the sidelink ranging resource set configuration parameter according to the first DCI. Alternatively, the processing unit 101 determines the sidelink ranging resource set configuration parameter based on first pre-configuration information.

In some embodiments, a sidelink ranging resource set configured by the sidelink ranging resource set configuration parameter is a periodic sidelink ranging resource set.

In some embodiments, the sidelink ranging resource set configuration parameter includes at least one of the following a period length, a number and a time-domain spacing of each group of sidelink ranging resources within a period, a time-domain start position and a time-domain length of each group of sidelink ranging resources in a time unit within the period, and a frequency-domain start position and a frequency-domain length of each group of sidelink ranging resources in the time unit within the period.

In some embodiments, the periodic sidelink ranging resource set includes one or more groups of sidelink ranging resources in each resource period, and each group of sidelink ranging resources includes one or more sidelink ranging resources, and each sidelink ranging resource is a resource in a same time unit.

In some embodiments, each sidelink ranging resource in a same group has a same location and a same size in a time unit.

In some embodiments, a same resource period includes multiple groups of sidelink ranging resources, and the multiple groups of sidelink ranging resources are configured by multiplexing time-domain resources in a time division manner, and/or by multiplexing frequency-domain resources in a frequency division manner.

In some embodiments, the communication unit 102 receives a second DCI sent by a network device, and the processing unit 101 determines, according to the second DCI, the sidelink ranging resource in a sidelink ranging resource set configured by the sidelink ranging resource configuration parameter. Alternatively, the processing unit 101 determines, based on a predefined rule, the sidelink ranging resource in the sidelink ranging resource set configured by the sidelink ranging resource configuration parameter.

In some embodiments, the communication unit 102 performs transmission of different sidelink ranging signals based on a same sidelink ranging resource.

In some embodiments, the communication unit 102 multiplexes, in the same sidelink ranging resource, frequency-domain resources in a comb frequency division multiplexing manner.

In some embodiments, the communication unit 102 is further configured to receive a third DCI sent by a network device, and determine a comb frequency division multiplexing factor according to the third DCI; or, determine a comb frequency division multiplexing factor based on second pre-configuration information: where the comb frequency division multiplexing factor is configured to indicate configuration information of resource elements occupied when the frequency-domain resources are multiplexed in the comb frequency division multiplexing manner.

In some embodiments, the third DCI and/or the second pre-configuration information is used to configure a comb frequency division multiplexing factor for each sidelink ranging resource, or is used to configure a comb frequency division multiplexing factor for a sidelink ranging resource set.

In some embodiments, the sidelink ranging resource set configuration parameter is used to configure multiple different sidelink ranging resource sets.

In some embodiments, the sidelink ranging resource set configuration parameter includes a comb frequency division multiplexing factor, with different comb frequency division multiplexing factors corresponding to different sidelink ranging resource sets.

In some embodiments, the communication unit 102 performs transmission of the sidelink ranging signal through at least one of the following manners: performing transmission of the sidelink ranging signal by using the sidelink ranging resource with a same frequency-domain width as a sidelink ranging resource set: performing transmission of the sidelink ranging signal by using the sidelink ranging resource with a same time-domain length as the sidelink ranging signal: performing transmission of the sidelink ranging signal by adopting a period corresponding to an integer multiple of a period of a sidelink ranging resource set: and performing repeated transmission of the sidelink ranging signal within a group of sidelink ranging resources within a same period, with a number of the repeated transmission of the sidelink ranging signal being less than or equal to a number of sidelink ranging resources in the corresponding group.

Regarding the apparatus in the above embodiment, the specific manner in which each module performs the operation has been described in detail in some embodiments of the method, and will not be described in detail here.

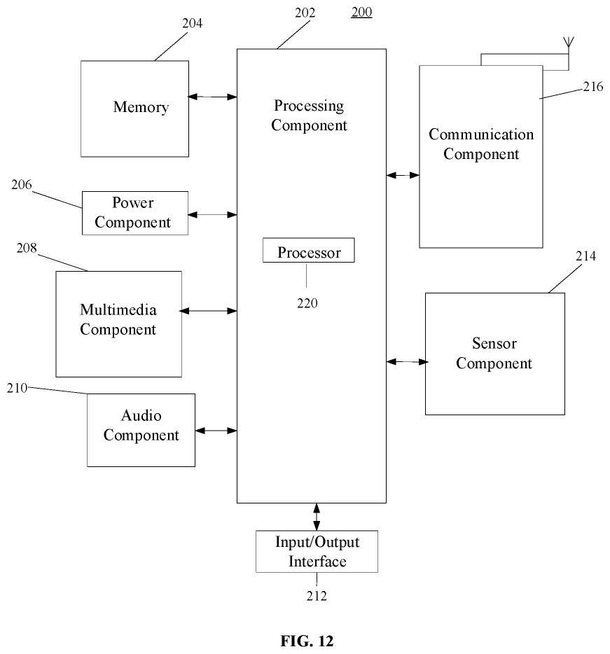

FIG. 12 is a block diagram of a device 200 for sidelink communication according to an exemplary embodiment. In some embodiments, the sidelink communication device 200 may be provided as the UE involved in the above embodiments. For example, the device 200 may be a mobile phone, a computer, a digital broadcast terminal, a messaging device, a game console, a tablet device, a medical device, a fitness device, a personal digital assistant, and the like.

Referring to FIG. 12, the device 200 may include one or more of the following components: a processing component 202, a memory 204, a power component 206, a multimedia component 208, an audio component 210, an input/output (I/O) interface 212, a sensor component 214, and a communication component 216.

The processing component 202 generally controls the overall operation of the device 200, such as operations associated with display, phone calls, data communications, camera operations, and recording operations. The processing component 202 may include one or more processors 220 to execute instructions to perform all or some of the steps of the methods described above. Additionally, the processing component 202 may include one or more modules that facilitate interaction between the processing component 202 and other components. For example, the processing component 202 may include a multimedia module to facilitate interaction between the multimedia component 208 and the processing component 202.

The memory 204 is configured to store various types of data to support operation at the device 200. Examples of such data include instructions, contact data, phonebook data, messages, pictures, videos, and the like for any application or method operating on the device 200. The memory 204 may be implemented by any type of volatile or non-volatile storage device or combination thereof, such as static random access memory (SRAM), electrically erasable programmable read only memory (EEPROM), erasable programmable read only memory (EPROM), programmable read only memory (PROM), read only memory (ROM), magnetic memory, flash memory, magnetic or optical disk.

The power component 206 provides power to various components of the device 200. The power components 206 may include a power management system, one or more power sources, and other components associated with generating, managing, and distributing power to the device 200.

The multimedia component 208 includes a screen that provides an output interface between the device 200 and the user. In some embodiments, the screen may include a liquid crystal display (LCD) and a touch panel (TP). If the screen includes a touch panel, the screen may be implemented as a touch screen to receive input signals from a user. The touch panel includes one or more touch sensors to sense touch, swipe, and gestures on the touch panel. The touch sensor may not only sense the boundaries of a touch or swipe action, but also detect the duration and pressure associated with the touch or swipe action. In some embodiments, the multimedia component 208 includes a front camera and/or a rear camera. When the device 200 is in an operation mode, such as a shooting mode or a video mode, the front camera and/or the rear camera may receive external multimedia data. Each of the front and rear cameras may be a fixed optical lens system or have focal length and optical zoom capability.

The audio component 210 is configured to output and/or input audio signals. For example, the audio component 210 includes a microphone (MIC) that is configured to receive external audio signals when the device 200 is in operating modes, such as calling mode, recording mode, and voice recognition mode. The received audio signal may be further stored in the memory 204 or transmitted via the communication component 216. In some embodiments, the audio component 210 also includes a speaker for outputting audio signals.

The I/O interface 212 provides an interface between the processing component 202 and a peripheral interface module, which may be a keyboard, a click wheel, a button, or the like. These buttons may include, but are not limited to: home button, volume buttons, start button, and lock button.

The sensor assembly 214 includes one or more sensors for providing status assessments of various aspects of the device 200. For example, the sensor assembly 214 can detect the open/closed state of the device 200, the relative positioning of components, such as the display and keypad of the device 200. The sensor assembly 214 can also detect a change in the position of the device 200 or a component of the device 200, the presence or absence of user contact with the device 200, the orientation or acceleration/deceleration of the device 200, and the temperature change of the device 200. The sensor assembly 214 may include a proximity sensor configured to detect the presence of nearby objects in the absence of any physical contact. The sensor assembly 214 may also include a light sensor, such as a CMOS or CCD image sensor, for use in imaging applications. In some embodiments, the sensor assembly 214 may also include an acceleration sensor, a gyroscope sensor, a magnetic sensor, a pressure sensor, or a temperature sensor.

The communication component 216 is configured to facilitate wired or wireless communication between the device 200 and other devices. The device 200 may access wireless networks based on communication standards, such as WiFi, 2G or 3G, or a combination thereof. In some embodiments, the communication component 216 receives broadcast signals or broadcast related information from an external broadcast management system via a broadcast channel. In some embodiments, the communication component 216 also includes a near field communication (NFC) module to facilitate short-range communication. For example, the NFC module may be implemented based on radio frequency identification (RFID) technology, infrared data association (IrDA) technology, ultra-wideband (UWB) technology, Bluetooth (BT) technology and other technologies.

In some embodiments, the device 200 may be implemented by one or more application specific integrated circuits (ASICs), digital signal processors (DSPs), digital signal processing devices (DSPDs), programmable logic devices (PLDs), field programmable gate array (FPGA), controller, microcontroller, microprocessor or other electronic component, which are configured to perform the above method.

In some embodiments, there is also provided a non-transitory computer-readable storage medium including instructions, such as the memory 204 including instructions, executable by the processor 220 of the device 200 to perform the method described above. For example, the non-transitory computer-readable storage medium may be ROM, random access memory (RAM), CD-ROM, magnetic tape, floppy disk, optical data storage device, and the like.

According to a first aspect of the embodiments of this disclosure, a sidelink communication method is provided and includes determining a sidelink ranging resource set configuration parameter, and determining a sidelink ranging resource based on the sidelink ranging resource set configuration parameter; and performing transmission of sidelink ranging signal through the sidelink ranging resource.

In some embodiments, determining the sidelink ranging resource set configuration parameter includes receiving a first downlink control information (DCI) sent by a network device, and determining the sidelink ranging resource set configuration parameter according to the first DCI; or, determining the sidelink ranging resource set configuration parameter based on first pre-configuration information.

In some embodiments, a sidelink ranging resource set configured by the sidelink ranging resource set configuration parameter is a periodic sidelink ranging resource set.

In some embodiments, the sidelink ranging resource set configuration parameter includes at least one of the following: a period length; a number and a time-domain spacing of each group of sidelink ranging resources within a period; a time-domain start position and a time-domain length of each group of sidelink ranging resources in a time unit within the period; a frequency-domain start position and a frequency-domain length of each group of sidelink ranging resources in the time unit within the period.

In some embodiments, the periodic sidelink ranging resource set includes one or more groups of sidelink ranging resources in each resource period, and each group of sidelink ranging resources includes one or more sidelink ranging resources, and each sidelink ranging resource is a resource in a same time unit.

In some embodiments, each sidelink ranging resource in a same group has a same location and a same size in a time unit.

In some embodiments, a same resource period includes multiple groups of sidelink ranging resources, and the multiple groups of sidelink ranging resources are configured by multiplexing time-domain resources in a time division manner, and/or by multiplexing frequency-domain resources in a frequency division manner.

In some embodiments, determining the sidelink ranging resource based on the sidelink ranging resource set configuration parameter includes: receiving a second DCI sent by a network device, and determining, according to the second DCI, the sidelink ranging resource in a sidelink ranging resource set configured by the sidelink ranging resource configuration parameter: or, determining, based on a predefined rule, the sidelink ranging resource in the sidelink ranging resource set configured by the sidelink ranging resource configuration parameter.

In some embodiments, performing transmission of the sidelink ranging signal through the sidelink ranging resource includes: performing transmission of different sidelink ranging signals based on a same sidelink ranging resource.

In some embodiments, performing transmission of the different sidelink ranging signals based on the same sidelink ranging resource includes multiplexing, in the same sidelink ranging resource, frequency-domain resources in a comb frequency division multiplexing manner.

In some embodiments, the sidelink communication method further includes: receiving a third DCI sent by a network device, and determining a comb frequency division multiplexing factor according to the third DCI; or, determining a comb frequency division multiplexing factor based on second pre-configuration information: wherein the comb frequency division multiplexing factor is configured to indicate configuration information of resource elements occupied when the frequency-domain resources are multiplexed in the comb frequency division multiplexing manner.

In some embodiments, the third DCI and/or the second pre-configuration information is used to configure a comb frequency division multiplexing factor for each sidelink ranging resource, or is used to configure a comb frequency division multiplexing factor for a sidelink ranging resource set.

In some embodiments, the sidelink ranging resource set configuration parameter is used to configure multiple different sidelink ranging resource sets.

In some embodiments, the sidelink ranging resource set configuration parameter includes a comb frequency division multiplexing factor, with different comb frequency division multiplexing factors corresponding to different sidelink ranging resource sets.

In some embodiments, performing transmission of the sidelink ranging signal through the sidelink ranging resource includes at least one of the following: performing transmission of the sidelink ranging signal by using the sidelink ranging resource with a same frequency-domain width as a sidelink ranging resource set: performing transmission of the sidelink ranging signal by using the sidelink ranging resource with a same time-domain length as the sidelink ranging signal: performing transmission of the sidelink ranging signal by adopting a period corresponding to an integer multiple of a period of a sidelink ranging resource set: and performing repeated transmission of the sidelink ranging signal within a group of sidelink ranging resources within a same period, with a number of the repeated transmission of the sidelink ranging signal being less than or equal to a number of sidelink ranging resources in the corresponding group.

According to a second aspect of the embodiments of this disclosure, there is provided a sidelink communication apparatus, the sidelink communication apparatus includes a processing unit, configured to determine a sidelink ranging resource set configuration parameter, and determine a sidelink ranging resource based on the sidelink ranging resource set configuration parameter: and a communication unit, configured to perform transmission of sidelink ranging signal through the sidelink ranging resource.

In some embodiments, the communication unit receives a first DCI sent by a network device, and the processing unit determines the sidelink ranging resource set configuration parameter according to the first DCI. Alternatively, the processing unit determines the sidelink ranging resource set configuration parameter based on first pre-configuration information.

In some embodiments, a sidelink ranging resource set configured by the sidelink ranging resource set configuration parameter is a periodic sidelink ranging resource set.

In some embodiments, the sidelink ranging resource set configuration parameter includes at least one of the following: a period length: a number and a time-domain spacing of each group of sidelink ranging resources within a period: a time-domain start position and a time-domain length of each group of sidelink ranging resources in a time unit within the period: a frequency-domain start position and a frequency-domain length of each group of sidelink ranging resources in the time unit within the period.

In some embodiments, the periodic sidelink ranging resource set includes one or more groups of sidelink ranging resources in each resource period, and each group of sidelink ranging resources includes one or more sidelink ranging resources, and each sidelink ranging resource is a resource in a same time unit.

In some embodiments, each sidelink ranging resource in a same group has a same location and a same size in a time unit.

In some embodiments, a same resource period includes multiple groups of sidelink ranging resources, and the multiple groups of sidelink ranging resources are configured by multiplexing time-domain resources in a time division manner, and/or by multiplexing frequency-domain resources in a frequency division manner.

In some embodiments, the communication unit receives a second DCI sent by a network device, and the processing unit determines, according to the second DCI, the sidelink ranging resource in a sidelink ranging resource set configured by the sidelink ranging resource configuration parameter. Alternatively, the processing unit determines, based on a predefined rule, the sidelink ranging resource in the sidelink ranging resource set configured by the sidelink ranging resource configuration parameter.

In some embodiments, the communication unit performs transmission of different sidelink ranging signals based on a same sidelink ranging resource.

In some embodiments, the communication unit multiplexes, in the same sidelink ranging resource, frequency-domain resources in a comb frequency division multiplexing manner.

In some embodiments, the communication unit is further configured to receive a third DCI sent by a network device, and determine a comb frequency division multiplexing factor according to the third DCI; or, determine a comb frequency division multiplexing factor based on second pre-configuration information: where the comb frequency division multiplexing factor is configured to indicate configuration information of resource elements occupied when the frequency-domain resources are multiplexed in the comb frequency division multiplexing manner.

In some embodiments, the third DCI and/or the second pre-configuration information is used to configure a comb frequency division multiplexing factor for each sidelink ranging resource, or is used to configure a comb frequency division multiplexing factor for a sidelink ranging resource set.

In some embodiments, the sidelink ranging resource set configuration parameter is used to configure multiple different sidelink ranging resource sets.

In some embodiments, the sidelink ranging resource set configuration parameter includes a comb frequency division multiplexing factor, with different comb frequency division multiplexing factors corresponding to different sidelink ranging resource sets.

In some embodiments, the communication unit performs transmission of the sidelink ranging signal through at least one of the following manners: performing transmission of the sidelink ranging signal by using the sidelink ranging resource with a same frequency-domain width as a sidelink ranging resource set: performing transmission of the sidelink ranging signal by using the sidelink ranging resource with a same time-domain length as the sidelink ranging signal: performing transmission of the sidelink ranging signal by adopting a period corresponding to an integer multiple of a period of a sidelink ranging resource set: and performing repeated transmission of the sidelink ranging signal within a group of sidelink ranging resources within a same period, with a number of the repeated transmission of the sidelink ranging signal being less than or equal to a number of sidelink ranging resources in the corresponding group.

It should be further understood that in this disclosure. “multiple/plurality of” refers to two or more, and other quantifiers are similar. The term “and/or”, which describes the association relationship of associated objects, means that there may be three kinds of relationships. For example, when referring to A and/or B, it may mean that A exists alone, both A and B exist, and B exists alone. The character “/” generally indicates that the associated objects are in an “or” relationship. The singular forms “a,” “the,” and “said” are intended to include the plural forms as well, unless the context clearly dictates otherwise.

It is further understood that the terms “first”. “second”, and the like are used to describe various information, but the information should not be limited to these terms. These terms are only used to distinguish the same type of information from one another, and do not imply a particular order or level of importance. In fact, the expressions “first”. “second” and the like are used completely interchangeably. For example, the first information may also be referred to as the second information, and similarly, the second information may also be referred to as the first information, without departing from the scope of this disclosure.

It is further to be understood that, although the operations in some embodiments of this disclosure are described in a specific order in the drawings, it should not be construed as requiring that the operations be performed in the specific order or the sequential order as shown, or requiring that all operations as shown be performed to obtain the desired result. In certain circumstances, multitasking and parallel processing may be advantageous.

Other embodiments of this disclosure will readily occur to those skilled in the art upon consideration of the specification and practice of the invention disclosed herein. This application is intended to cover any variations, uses, or adaptations of this disclosure that follow the general principles of this disclosure and include common knowledge or techniques in the technical field not disclosed by this disclosure. The specification and examples are to be regarded as exemplary only, with the true scope and spirit of the disclosure being indicated by the following claims.

It is to be understood that this disclosure is not limited to the precise structures described above and illustrated in the accompanying drawings, and that various modifications and changes may be made without departing from the scope thereof. The scope of this disclosure is limited only by the appended claims.

1. A sidelink communication method, performed by a terminal device, comprising:
determining a sidelink ranging resource set configuration parameter, and determining a sidelink ranging resource based on the sidelink ranging resource set configuration parameter; and
performing transmission of sidelink ranging signal through the sidelink ranging resource.

2. The sidelink communication method according to claim 1, wherein determining the sidelink ranging resource set configuration parameter comprises:
receiving a first downlink control information (DCI) sent by a network device, and determining the sidelink ranging resource set configuration parameter according to the first DCI; or,
determining the sidelink ranging resource set configuration parameter based on first pre-configuration information.

3. The sidelink communication method according to claim 1, wherein a sidelink ranging resource set configured by the sidelink ranging resource set configuration parameter is a periodic sidelink ranging resource set.

4. The sidelink communication method according to claim 3, wherein the sidelink ranging resource set configuration parameter comprises at least one of following:
a period length;
a number and a time-domain spacing of each group of sidelink ranging resources within a period;
a time-domain start position and a time-domain length of each group of sidelink ranging resources in a time unit within the period;
a frequency-domain start position and a frequency-domain length of each group of sidelink ranging resources in the time unit within the period.

5. The sidelink communication method according to claim 4, wherein the periodic sidelink ranging resource set comprises one or more groups of sidelink ranging resources in each resource period, and each group of sidelink ranging resources comprises one or more sidelink ranging resources, and each sidelink ranging resource is a resource in a same time unit.

6. The sidelink communication method according to claim 5, wherein each sidelink ranging resource in a same group has a same location and a same size in a time unit.

7. The sidelink communication method according to claim 5, wherein a same resource period comprises multiple groups of sidelink ranging resources, and the multiple groups of sidelink ranging resources are configured by multiplexing time-domain resources in a time division manner, and/or by multiplexing frequency-domain resources in a frequency division manner.

8. The sidelink communication method according to claim 1, wherein determining the sidelink ranging resource based on the sidelink ranging resource set configuration parameter comprises:
receiving a second DCI sent by a network device, and determining, according to the second DCI, the sidelink ranging resource in a sidelink ranging resource set configured by the sidelink ranging resource configuration parameter; or,
determining, based on a predefined rule, the sidelink ranging resource in the sidelink ranging resource set configured by the sidelink ranging resource configuration parameter.

9. The sidelink communication method according to claim 1, wherein performing transmission of the sidelink ranging signal through the sidelink ranging resource comprises:
performing transmission of different sidelink ranging signals based on a same sidelink ranging resource.

10. The sidelink communication method according to claim 9, wherein performing transmission of the different sidelink ranging signals based on the same sidelink ranging resource comprises:
multiplexing, in the same sidelink ranging resource, frequency-domain resources in a comb frequency division multiplexing manner.

11. The sidelink communication method according to claim 10, further comprising:
receiving a third DCI sent by a network device, and determining a comb frequency division multiplexing factor according to the third DCI; or,
determining a comb frequency division multiplexing factor based on second pre-configuration information;
wherein the comb frequency division multiplexing factor is configured to indicate configuration information of resource elements occupied when the frequency-domain resources are multiplexed in the comb frequency division multiplexing manner.

12. The sidelink communication method according to claim 11, wherein the third DCI and/or the second pre-configuration information is used to configure a comb frequency division multiplexing factor for each sidelink ranging resource, or is used to configure a comb frequency division multiplexing factor for a sidelink ranging resource set.

13. The sidelink communication method according to claim 1, wherein the sidelink ranging resource set configuration parameter is used to configure multiple different sidelink ranging resource sets.

14. The sidelink communication method according to claim 13, wherein the sidelink ranging resource set configuration parameter comprises a comb frequency division multiplexing factor, with different comb frequency division multiplexing factors corresponding to different sidelink ranging resource sets.

15. The sidelink communication method according to claim 1, wherein performing transmission of the sidelink ranging signal through the sidelink ranging resource comprises at least one of following:
performing transmission of the sidelink ranging signal by using the sidelink ranging resource with a same frequency-domain width as a sidelink ranging resource set;
performing transmission of the sidelink ranging signal by using the sidelink ranging resource with a same time-domain length as the sidelink ranging signal;
performing transmission of the sidelink ranging signal by adopting a period corresponding to an integer multiple of a period of a sidelink ranging resource set; and
performing repeated transmission of the sidelink ranging signal within a group of sidelink ranging resources within a same period, with a number of the repeated transmission of the sidelink ranging signal being less than or equal to a number of sidelink ranging resources in the corresponding group.

16. (canceled)

17. A sidelink communication device, comprising:
a processor; and
a memory for storing instructions executable by the processor;
wherein, the processor is configured to determine a sidelink ranging resource set configuration parameter, determine a sidelink ranging resource based on the sidelink ranging resource set configuration parameter; and perform transmission of sidelink ranging signal through the sidelink ranging resource.

18. A non-transitory computer-readable storage medium for storing instructions therein, wherein the instructions in the storage medium, when being executed by a processor of a user equipment, cause the user equipment to implement operations comprising:
determining a sidelink ranging resource set configuration parameter, and determining a sidelink ranging resource based on the sidelink ranging resource set configuration parameter; and
performing transmission of sidelink ranging signal through the sidelink ranging resource.

19. The sidelink communication method according to claim 2, wherein performing transmission of the sidelink ranging signal through the sidelink ranging resource comprises:
performing transmission of different sidelink ranging signals based on a same sidelink ranging resource.

20. The sidelink communication method according to claim 8, wherein performing transmission of the sidelink ranging signal through the sidelink ranging resource comprises:
performing transmission of different sidelink ranging signals based on a same sidelink ranging resource.

21. The sidelink communication method according to claim 2, wherein performing transmission of the sidelink ranging signal through the sidelink ranging resource comprises at least one of following:
performing transmission of the sidelink ranging signal by using the sidelink ranging resource with a same frequency-domain width as a sidelink ranging resource set;
performing transmission of the sidelink ranging signal by using the sidelink ranging resource with a same time-domain length as the sidelink ranging signal;
performing transmission of the sidelink ranging signal by adopting a period corresponding to an integer multiple of a period of a sidelink ranging resource set; and
performing repeated transmission of the sidelink ranging signal within a group of sidelink ranging resources within a same period, with a number of the repeated transmission of the sidelink ranging signal being less than or equal to a number of sidelink ranging resources in the corresponding group.
